(19) United States
(12) Patent Application Publication
(10) Pub. No.: US 2024/0356767 A1
(43) Pub. Date: Oct. 24, 2024

(54) DATA STORAGE METHOD, APPARATUS, ELECTRONIC DEVICE, AND NON-TRANSITORY COMPUTER-READABLE STORAGE MEDIUM

(71) Applicants: Beijing BOE Technology Development Co., Ltd., Beijing (CN); BOE Technology Group Co., Ltd., Beijing (CN)

(72) Inventors: Lirong XU, Beijing (CN); Hongxiang SHEN, Beijing (CN); Xiao CHU, Beijing (CN); Xiying ZHANG, Beijing (CN); Mingyuan MA, Beijing (CN)

(21) Appl. No.: 18/035,488

(22) PCT Filed: Apr. 29, 2022
(86) PCT No.: PCT/CN2022/090686

§ 371 Date: May 4, 2023

(51) Int. Cl. H04L 9/00; H04L 9/32

(52) U.S. Cl. CPC H04L 9/50; H04L 9/3218; H04L 9/3247

(57) ABSTRACT

A data storage method, a data storage apparatus, an electronic device, and a non-transitory computer-readable storage medium. The method is applied to a node device deployed with a blockchain node, wherein the blockchain node belongs to a user blockchain network and an object blockchain network, the user blockchain network is used to store evaluation data generated by evaluation behavior of a target user on at least one object, and the object blockchain network is used to store evaluation data generated by at least one user performing evaluation behavior on the target object, the method includes: obtaining target evaluation data on a target object, the target evaluation data being generated by the target user performing target evaluation behavior on the target object; storing the target evaluation data separately to the user blockchain network and the object blockchain network through the blockchain node.

### TECHNICAL FIELD

The present disclosure relates to the field of internet technology, and more particularly, to a data storage method, a data storage apparatus, an electronic device, and a non-transitory computer-readable storage medium.

### BACKGROUND

At present, online systems usually provide users with evaluation functions for purchase behaviors, in order to achieve feedback on purchase behaviors. For example, after completing purchase behaviors such as watching a video, purchasing a product, and shopping in a store, a user can evaluate the corresponding item. The data generated from the above evaluation will be stored in a centralized manner on an online system server for display to the user or others.

For the centralized storage mentioned above, the security of data depends on protective measures of the server per se, so there are inevitably security risks such as data leakage or malicious tampering.

### SUMMARY

In view of the above, the present disclosure provides a data storage method, a data storage apparatus, an electronic device, and a non-transitory computer-readable storage medium, to address the deficiency in the related art.

According to a first aspect of the embodiments of the present disclosure, there is provided a data storage method, applied to a node device deployed with a blockchain node, wherein the blockchain node belongs to a user blockchain network and an object blockchain network, the user blockchain network is used to store evaluation data generated by evaluation behavior of a target user on at least one object, and the object blockchain network is used to store evaluation data generated by at least one user performing evaluation behavior on the target object, the method includes:
obtaining target evaluation data on a target object, the target evaluation data being generated by the target user performing target evaluation behavior on the target object;
storing the target evaluation data separately to the user blockchain network and the object blockchain network through the blockchain node.

Optionally, the blockchain node includes a first blockchain node belonging to the user blockchain network and a second blockchain node belonging to the object blockchain network, wherein storing the target evaluation data separately to the user blockchain network and the object blockchain network through the blockchain node includes:

storing the target evaluation data to the user blockchain network through the first blockchain node, and storing the target evaluation data to the object blockchain network through the second blockchain node.

Optionally, storing the target evaluation data separately to the user blockchain network and the object blockchain network through the blockchain node includes:
generating a first evaluation block and a second evaluation block respectively based on the target evaluation data;
updating the first evaluation block to a first blockchain ledger maintained by the user blockchain network, and updating the second evaluation block to a second blockchain ledger maintained by the object blockchain network.

Optionally, generating a first evaluation block and a second evaluation block respectively based on the target evaluation data includes:
generating a first evaluation block based on first historical evaluation data and the target evaluation data, and generating a second evaluation block based on second historical evaluation data and the target evaluation data; or,
generating a first evaluation block based on data summary of the first historical evaluation data and the target evaluation data, and generating a second evaluation block based on data summary of the second historical evaluation data and the target evaluation data;
wherein the first historical evaluation data was generated by the target user performing a first historical evaluation behavior on at least one object before the target evaluation behavior, and the second historical evaluation data was generated by at least one user performing a second historical evaluation behavior on the target object before the target evaluation behavior.

Optionally, the method further includes:
when the first evaluation block is a first block of the first blockchain ledger, setting identity information of the target user as a ledger identification of the first blockchain ledger;
and/or,
when the second evaluation block is a first block of the second blockchain ledger, setting identification information of the target object as a ledger identification of the second blockchain ledger.

Optionally, storing the target evaluation data in any blockchain network includes:
encrypting the target evaluation data and storing the encrypted ciphertext evaluation data in any blockchain network.

Optionally, storing the target evaluation data in any blockchain network includes:
obtaining target purchase data corresponding to the target evaluation behavior, the target purchase data being generated by the target user performing target purchase behavior on the target object;
associating the target evaluation data with the target purchase data and storing the target evaluation data and the target purchase data in any blockchain network.

Optionally, a signature generated from a private key of the target user is added by a client of the target user to the target evaluation data, and storing the target evaluation data in any blockchain network includes:
verifying the signature with a public key of the client;
in response to the signature is verified, storing the target evaluation data in any blockchain network.

Optionally, storing the target evaluation data in any blockchain network includes:
determining a diversity degree of evaluations of the target user based on historical evaluation records of the target user;
in response to the diversity degree of evaluations meeting a preset diversity degree threshold, storing the target evaluation data to any blockchain network.

Optionally, the target user is pre-registered to a server, and a corresponding registration process is implemented based on a zero-knowledge proof algorithm.

Optionally, a proof circuit of the zero-knowledge proof algorithm is generated according to identity information of the target user and/or device information of the terminal device used by the target user.

Optionally, the method further includes:
in response to determining that the target evaluation data has been successfully stored in the user blockchain network and/or the object blockchain network, triggering allocation of an available benefit corresponding to the target evaluation data and/or the target evaluation behavior to the target user.

Optionally, the method further includes:
in response to an evaluation cancellation request initiated for the target evaluation data, triggering the blockchain node to execute a corresponding evaluation cancellation transaction, the evaluation cancellation transaction being used to freeze a permission of a preset type of blockchain nodes to read the stored target evaluation data.

Optionally, the method further includes:
receiving a data acquisition request initiated by a requesting party for any evaluation behavior, the acquisition request including time information of the evaluation behavior, a user identification of the user who implemented the evaluation behavior, and an object identification of a corresponding object of the evaluation behavior;
obtaining a stored first to-be-verified data from the user blockchain network based on the time information and the object identification, and obtaining a stored second to-be-verified data from the object blockchain network based on the time information and the user identification;
if the first to-be-verified data and the second to-be-verified data are identical, returning the data to the requesting party.

According to a second aspect of the embodiments of the present disclosure, there is provided a data storage apparatus, applied to a node device deployed with a blockchain node, wherein the blockchain node belongs to a user blockchain network and an object blockchain network, the user blockchain network is used to store evaluation data generated by evaluation behavior of a target user on at least one object, and the object blockchain network is used to store evaluation data generated by at least one user performing evaluation behavior on the target object, and the apparatus includes one or more processors configured to:
obtain target evaluation data on a target object, the target evaluation data being generated by the target user performing target evaluation behavior on the target object;
store the target evaluation data separately to the user blockchain network and the object blockchain network through the blockchain node.

Optionally, the blockchain node includes a first blockchain node belonging to the user blockchain network and a second blockchain node belonging to the object blockchain network, and the processors are further configured to:
store the target evaluation data to the user blockchain network through the first blockchain node, and store the target evaluation data to the object blockchain network through the second blockchain node.

Optionally, the processors are further configured to:
generate a first evaluation block and a second evaluation block respectively based on the target evaluation data;
update the first evaluation block to a first blockchain ledger maintained by the user blockchain network, and update the second evaluation block to a second blockchain ledger maintained by the object blockchain network.

Optionally, the processors are further configured to:
generate a first evaluation block based on first historical evaluation data and the target evaluation data, and generate a second evaluation block based on second historical evaluation data and the target evaluation data; or,
generate a first evaluation block based on data summary of the first historical evaluation data and the target evaluation data, and generate a second evaluation block based on data summary of the second historical evaluation data and the target evaluation data;
wherein the first historical evaluation data was generated by the target user performing a first historical evaluation behavior on at least one object before the target evaluation behavior, and the second historical evaluation data was generated by at least one user performing a second historical evaluation behavior on the target object before the target evaluation behavior.

Optionally, the processors are further configured to:
when the first evaluation block is a first block of the first blockchain ledger, set identity information of the target user as a ledger identification of the first blockchain ledger; and/or,
when the second evaluation block is a first block of the second blockchain ledger, set identification information of the target object as a ledger identification of the second blockchain ledger.

Optionally, the processors are further configured to:
encrypt the target evaluation data and store the encrypted ciphertext evaluation data in any blockchain network.

Optionally, the processors are further configured to:
obtain target purchase data corresponding to the target evaluation behavior, the target purchase data being generated by the target user performing target purchase behavior on the target object;
associate the target evaluation data with the target purchase data and store the target evaluation data and the target purchase data in any blockchain network.

Optionally, a signature generated from a private key of the target user is added by a client of the target user to the target evaluation data, and the processors are further configured to:
verify the signature with a public key of the client;
in response to the signature is verified, store the target evaluation data in any blockchain network.

Optionally, the processors are further configured to:
determine a diversity degree of evaluations of the target user based on historical evaluation records of the target user;
in response to the diversity degree of evaluations meeting a preset diversity degree threshold, store the target evaluation data to any blockchain network.

Optionally, the target user is pre-registered to a server, and a corresponding registration process is implemented based on a zero-knowledge proof algorithm.

Optionally, a proof circuit of the zero-knowledge proof algorithm is generated according to identity information of the target user and/or device information of the terminal device used by the target user.

Optionally, the processors are further configured to:

in response to determining that the target evaluation data has been successfully stored in the user blockchain network and/or the object blockchain network, trigger allocation of an available benefit corresponding to the target evaluation data and/or the target evaluation behavior to the target user.

Optionally, the processors are further configured to:
in response to an evaluation cancellation request initiated for the target evaluation data, triggering the blockchain node to execute a corresponding evaluation cancellation transaction, the evaluation cancellation transaction being used to freeze a permission of a preset type of blockchain nodes to read the stored target evaluation data.

Optionally, the processors are further configured to:
receive a data acquisition request initiated by a requesting party for any evaluation behavior, the acquisition request including time information of the evaluation behavior, a user identification of the user who implemented the evaluation behavior, and an object identification of a corresponding object of the evaluation behavior;
obtain a stored first to-be-verified data from the user blockchain network based on the time information and the object identification, and obtaining a stored second to-be-verified data from the object blockchain network based on the time information and the user identification;
if the first to-be-verified data and the second to-be-verified data are identical, returning the data to the requesting party.

According to a third aspect of the embodiments of the present disclosure, there is provided an electronic device including: a processor; a memory used to store processor executable instructions; wherein the processor is configured to implement the data storage method according to the above first aspect.

According to a fourth aspect of the embodiments of the present disclosure, there is provided a non-transitory computer-readable storage medium on which a computer program is stored, wherein, when the program is executed by a processor, the computer program implements steps of the data storage method according to the above first aspect.

According to the embodiments of the present disclosure, a blockchain node belonging to a user blockchain network and an object blockchain network is deployed in the node device, wherein the user blockchain network is used to store evaluation data generated by the target user's evaluation behavior on at least one object, and the object blockchain network is used to store evaluation data generated by at least one user's evaluation behavior on the target object. Based on this, after obtaining the target evaluation data generated by the target user's target evaluation behavior on the target object, the node device can store the data separately to the user blockchain network and the object blockchain network through the blockchain node.

Blockchain technology is a new application model of computer technologies such as distributed data storage, peer-to-peer transmission, consensus mechanism, and encryption algorithms. In a blockchain system, data blocks are sequentially connected in chronological order to form a chain like data structure, which is cryptologically guaranteed to be tamperproof and unforgeable in a distributed ledger. Therefore, through blockchain nodes, the target evaluation data generated by the target user's implementation of target evaluation behavior can be stored separately in the user blockchain network and the object blockchain network. On the one hand, reliable storage of this data can be achieved based on the technical capabilities of the two blockchain networks per se. Moreover, cross verification can also be performed between the target evaluation data stored separately in the two blockchain networks, thereby further ensuring the security and consistency of the stored data.

It is to be understood that the above general descriptions and the below detailed descriptions are merely exemplary and explanatory, and are not intended to limit the present disclosure.

### BRIEF DESCRIPTION OF THE DRAWINGS

In order to provide a clearer explanation of the technical solution in the disclosed embodiments, a brief introduction will be given to the accompanying drawings to be used in the description of the embodiments. Apparently, the accompanying drawings in the following description are only some embodiments of the present disclosure. For those ordinarily skilled in the art, other accompanying drawings can be obtained based on these drawings without any creative effort.

FIG. 1 is a schematic diagram illustrating an architecture of an online system according to an embodiment of the present disclosure.

FIG. 2 is a flowchart illustrating a data storage method according to an embodiment of the present disclosure.

FIG. 3 is a schematic diagram illustrating a structure of a node device according to an embodiment of the present disclosure.

FIG. 4 is a schematic diagram illustrating a structure of another node device according to an embodiment of the present disclosure.

FIG. 5 is a schematic diagram illustrating a chain structure of a blockchain ledger according to an embodiment of the present disclosure.

FIG. 6 is a schematic block diagram illustrating a data storage apparatus according to an embodiment of the present disclosure.

### DETAILED DESCRIPTION OF THE EMBODIMENTS

The following will provide a clear and complete description of the technical solution in the disclosed embodiment in conjunction with the accompanying drawings. Apparently, the described embodiments are only a part of the disclosed embodiments, not all of them. Based on the embodiments in the present disclosure, all other embodiments obtained by those ordinarily skilled in the art without creative labor fall within the scope of protection in the present disclosure.

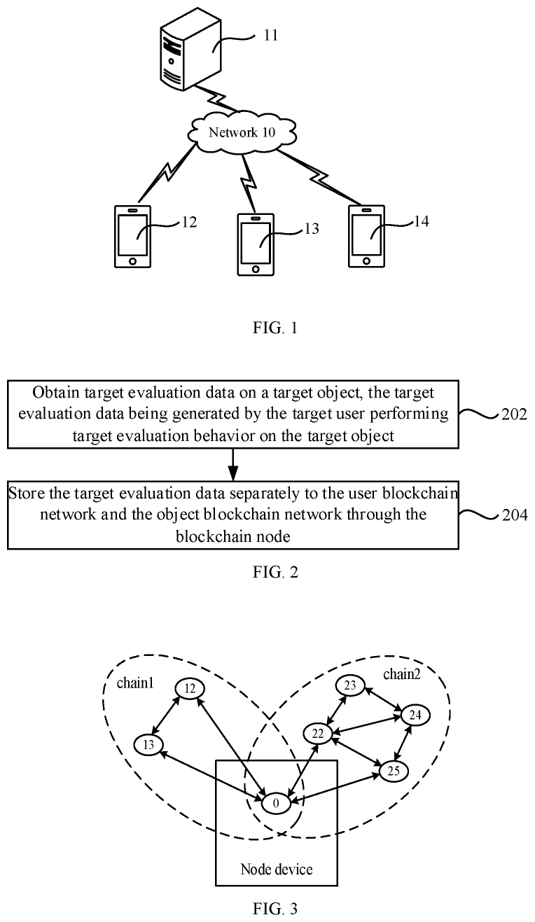

FIG. 1 is a schematic diagram illustrating an architecture of an online system according to an embodiment of the present disclosure. As shown in FIG. 1, the system can include a network 10, a server 11, one or more electronic devices, such as a mobile phone 12, a mobile phone 13, and a mobile phone 14.

The server 11 can be a physical server containing a stand-alone host, or it can be a virtual server, a cloud server, and the like, hosted by a cluster of hosts. The mobile phone 12-14 are only a type of terminal devices that users can operate. In practice, users can also use the following types of terminal devices: tablet devices, laptops, personal digital assistants, wearable devices (such as smart glasses, smart watches, etc.), VR (Virtual Reality) devices, AR (Augmented Reality) devices, and the like. The one or more embodiments of this specification do not limit this. The network 10 can include various types of wired or wireless networks.

The mobile phones 12-14 can run clients corresponding to the server 11, so that through respective clients running thereon, the mobile phones 12-14 can interact with the server 11. The client can essentially be an application (APP), which can be pre-installed on the terminal device, so that the client can be started and run on the terminal device. However, when using online “clients” such as HTML5 technology, it is not necessary to install corresponding applications on the terminal devices to obtain and run the clients.

The server 11 can cooperate with the mobile phones 12-14 to provide users with online purchase and evaluation functions. For example, after purchasing a product online, a user can evaluate a purchasing experience on the product, the delivery, and other aspects online with his mobile phone 12. For example, after a user places an order for an offline store online and completes his purchase in that store, he can evaluate the store, the products, and other purchase behaviors online with his mobile phone 13. For example, after watching a certain video or an article, a user can evaluate the video or the article with his mobile phone 14, and so on. The evaluation process can generate corresponding evaluation data, and the solution of the present disclosure can be used to store the evaluation data generated by the process.

Here, the node device described in the present disclosed embodiment can be the server 11, the mobile phones 12-14, and other devices besides the server 11 and the mobile phones 12-14. The following examples will be explained separately for different situations of node devices, and will not be elaborated here.

The following provides a detailed description of the disclosed data storage solution in conjunction with the accompanying drawings and corresponding embodiments.

FIG. 2 is a flowchart illustrating a data storage method according to an embodiment of the present disclosure. As shown in FIG. 2, this method is applied to a node device deployed with a blockchain node, which belong to both a user blockchain network and an object blockchain network. The user blockchain network is used to store evaluation data generated by an evaluation behavior of the target user for at least one object, and the object blockchain network is used to store evaluation data generated by at least one evaluation behavior of at least one user on the target object. This method can include the following steps 202-204:

At Step 202, target evaluation data on a target object is obtained, the target evaluation data being generated by the target user performing a target evaluation behavior on the target object.

It should be noted that the target object mentioned in the present disclosure can be products (such as clothing, household appliances, etc.), stores (online virtual stores, offline stores, etc.), multimedia resources (short videos, movies, articles, etc.), events, and any other form. The target evaluation behavior can be in any form such as editing comment, rating a scoring, and selecting options of descriptions. The generated target evaluation data can be in any form such as text (text, numbers, etc.), images, or videos, and the present disclosure does not limit this.

In addition, due to the fact that the target evaluation data is generated by the target user performing a target evaluation behavior on the target object, in some cases, sensitive issues such as data ownership or disclosure scope may be involved. In order to avoid potential disputes caused by the above issues, a node device can obtain the target evaluation data with necessary authorization from all relevant parties. Here, the relevant parties may include but are not limited to the target user, all parties of the target object, the management party of the online system, etc., which will not be elaborated.

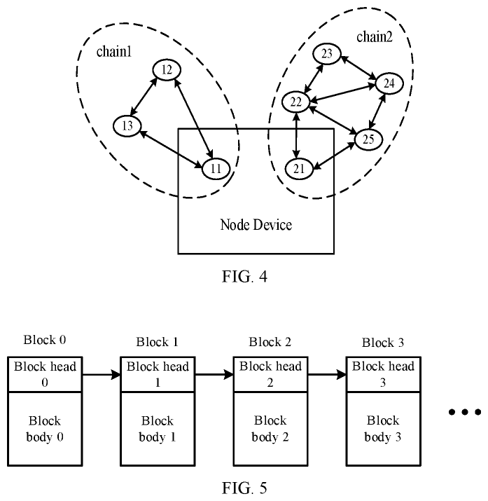

In the embodiments of the present disclosure, a blockchain node is deployed in the node device, and in the embodiments of the present disclosure, the blockchain node is used to store data to the user blockchain network and the object blockchain network respectively. Here, the blockchain node belongs to the user blockchain network and the object blockchain network, that is, the blockchain node is a node member (hereinafter referred to as a node) of both blockchain networks, and on the other hand, is a part constituting both blockchain networks. Apparently, from the perspective of hardware devices, the above-mentioned node device also participates in both blockchain networks. In practice, the blockchain nodes can be deployed in various ways within the node device, resulting in different meanings of “belonging”. The following will be explained in conjunction with FIGS. 3-4.

In one embodiment, a blockchain node can be deployed in the node device, and the node is a member of both the user blockchain network and the object blockchain network, and the node is a part constituting both blockchain networks. As shown in FIG. 3, node0 is deployed in the node device, where node0, together with nodes such as node12 and node13, forms chain1; on the other hand, node0, together with nodes such as node22, node23, node24, and node25, forms chain2. It can be seen that at this point, node0 is the blockchain node, chain1 is the user blockchain network, and chain1 is the object blockchain network. Here, the node device can initiate a process locally and create a node instance within that process to run blockchain platform code and load relevant node data, thereby completing the deployment of node0 within that process.

In this scenario, node0 is both a node of chain1 and a node of chain2. It can be seen that node0 participates in running both chain1 and chain2. Moreover, when node0 participates in running chain 1, other nodes in chain 1 can treat node1 as an independent single node. When node0 participates in running chain 2, other nodes in chain 2 can also treat node1 as an independent single node. That is, when node participates in any one blockchain network, the other blockchain network has no impact on this running process. Node0 generates corresponding blockchain data while processing blockchain transactions separately over the two blockchain networks (such as submitting blockchain transactions, participating in transaction consensus, executing blockchain transactions, deploying smart contracts, calling smart contracts, etc.). In order to avoid confusion in transactions and data, chain1 and chain2 can be assigned with different network identifications. The transactions generated in a network and the corresponding blockchain data carry the network identification of that network, so that node0 can identify whether any blockchain transaction processed belongs to chain1 or chain2 based on the network identification, and store the blockchain data corresponding to the transaction in the corresponding database. Here, the databases corresponding to chain1 and chain2 can be isolated from each other, and any database can run locally on the node device or other storage devices. With this method, isolation of transactions and data between the two networks can be achieved while node0 participates in both chain1 and chain2 simultaneously.

In another embodiment, two blockchain nodes can also be deployed in the node device. The two blockchain nodes are node members respectively of the user blockchain network and the object blockchain network, and are parts constituting these two blockchain networks. As shown in FIG. 4, node11 and node21 are deployed in the node device, where node11, together with nodes such as node12 and node13, forms chain1; node21, together with nodes such as node22, node23, node24, and node25, forms chain2. It can be seen that at this point, node11 and node21 are the blockchain nodes, chain1 is the user blockchain network, and chain1 is the object blockchain network. Here, the node device can also deploy node11 and node21 locally through the aforementioned method of pulling up processes, and the specific process will not be repeated. However, it should be noted that the above node11 and node21 can be deployed (as different node instances) in the same process to reduce the process maintenance stress on the node device. Alternatively, the two can be deployed separately in two processes, so that the two nodes can independently invoke the available resources of the node device, and it is more convenient to achieve transaction and data isolation between the two nodes. Furthermore, in order to better achieve the isolation of node11 and node21, when the two nodes are deployed in different processes, the above processes can also run in different containers (such as Docker containers), which will not be further elaborated.

In this scenario, node11 is a node of chain1, not a node of chain2; node 21 is a node of chain 2, not chain 1. It can be seen that node11 and node21 are not related to the blockchain network to which the other node belongs. In other words, except for being deployed on the same node device, node1 and node21 are not related to each other in terms of the blockchain transactions processed and the blockchain data maintained. Node11 and node21 are two independent blockchain nodes, and correspondingly, chain1 and chain2 are independent blockchain networks. therefore, the transactions and data of the two networks are naturally isolated from each other. Therefore, the first and second blockchain networks in this scenario can separately and independently store evaluation data. Similarly, in this scenario, the databases corresponding to node11 and node21 can also be isolated from each other, and any database can run locally on the node device or other storage devices, which will not be further elaborated.

It can be understood that the aforementioned “deploying one blockchain node in the node device” and “deploying two blockchain nodes in the node device” are both nodes used for storing target evaluation data as described in the disclosed embodiment. In practice, other blockchain nodes can also be deployed in the node device, so that the node device can achieve corresponding functions through other blockchain nodes. However, since the other blockchain nodes are not associated with the data storage solution, the present disclosure does not limit this.

In addition, the node device described in the present disclosure can be a terminal device used by the target user, such as the mobile phones 12-14 shown in FIG. 1. In addition to deploying the blockchain node, the device also deploys a client corresponding to the evaluation behavior. For example, the user can implement the target evaluation behavior in the evaluation page displayed by the client on the target object, so that the client can collect corresponding target evaluation data. At this point, the client can send the target evaluation data to the node for storage. In this scenario, the node device shown in FIG. 4 can be the mobile phone 12 shown in FIG. 1. At this point, node12 in chain1 can be on server 11, node13 can be on a third-party device or the like; node 22 in chain 2 can be located on server 11, while nodes 23 to 25 can be located on terminal devices used by other users. Alternatively, the node device can also be the server where the server of the online system is located, as server 11 shown in FIG. 1. At this point, the client running on the terminal device of the target user can upload the target evaluation data to the server after collecting the target evaluation data, so that the server can submit the target evaluation data to the blockchain node for storage. At this point, node12 in chain1 can be in the mobile phone 1, node13 can be in a third-party device or the like; nodes 22 to 25 in chain 2 can be located on terminal devices used by other users. Alternatively, the node device can also be other devices (excluding servers and terminal devices), in which case the client can directly send the collected target evaluation data to the device, or the target evaluation data can be submitted to the server, and the server can send the data to the device. Furthermore, after receiving the target evaluation data, the other devices can submit the target evaluation data to the blockchain node for storage.

As mentioned above, the user blockchain network is used to store evaluation data generated by the evaluation behavior of the target user for at least one object, while the object blockchain network is used to store evaluation data generated by the evaluation behavior of at least one user on the target object. It can be seen that user blockchain network and the object blockchain network are essentially two types of blockchain networks. Here, the user blockchain network is a network specified for a user, that is, a plurality of users corresponding to the online system can each correspond to one user blockchain network, and different users correspond to different user blockchain networks. The present disclosure focuses on the target user corresponding to the user blockchain network. The object blockchain network is a network specified for an object, that is, a plurality of objects corresponding to the online system can each correspond to one object blockchain network, and different objects correspond to different object blockchain networks. The present disclosure focuses on the user blockchain network corresponding to the target object.

In one embodiment, the client of the target user can interact with the corresponding server. Here, in order to meet the temporary interaction needs of the user or in some other scenarios, the user can interact with the server through the client without registering with the server. For example, the user can use the client as a temporary identity such as “visitor” or “preview” to control the interaction between the client and the server based on temporary identity, for example, submitting target evaluation data to the server as a “visitor”.

However, considering that the services provided by online system to users usually require clear identity and permission restrictions, in order to better and fully enjoy the online services provided by the server, users can also register to the server, and then log in to the server with their registered identity. For example, if the user is not registered, they use a temporary account; during the registration process, the server creates a personal account for the user, and then the user can log in to the client using that account. Here, in order to avoid disclosing sensitive information to the server during the registration process, to reduce the potential security risks to the user's personal privacy, and to ensure that the registered account corresponds to the terminal device used by the user, the above registration process can be implemented based on a zero-knowledge proof algorithm. The following is an example of the user using the client running in the terminal device to register an account, as an example of the specific implementation process of this algorithm.

When the target user registers an account based on the terminal device he is operating, the terminal device can obtain its own device information, which can be specified by the target user or pre-recorded locally on the terminal device. Here, the information is used to uniquely identify the terminal device, which can be information such as a device number sn, a device key sk, and/or a device type ct of the terminal device. In addition, identity information such as personal information (such as account ID), custom code, and/or information known to other users can also be obtained from the target user, which will not be further elaborated. Based on the device information and/or identity information obtained through the above methods, a vector X can be generated, which can be used as key data for subsequent steps.

Furthermore, the terminal device can send the vector X to a management server, and the management server can provide device registration, key management, certificate management, and other services for the terminal device. Furthermore, the server generates a basic polynomial C (X) based on the vector and defines a random number generation algorithm R (X). The unique input parameter of the algorithm is a random number r, which can be generated using a pre-defined random number generation algorithm. At this point, the management server can further determine a verification polynomial F (X)=C (X) R (r), and compile the verification polynomial into a circuit, that is, a zero-knowledge proof circuit. The circuit can be composed of several gates, such as addition gates and multiplication gates, with each gate having several input pins and several output pins. Each gate can perform an addition or multiplication operation, and so on. Based on this, in each proof process, the values on the connecting lines of each gate can be obtained. By verifying whether the input and output values of each gate meet the addition or multiplication equations, it can be determined whether the terminal device sending the target user participated in the proof process, that is, whether the data was indeed sent by the legitimate device logged in by the legitimate user. It can be seen that the proof circuit of the zero-knowledge proof algorithm described in the solution can be generated according to the identity information of the target user and/or the device information of the terminal device of the client of the user. With this method, it can be ensured that the users who pass the final verification correspond one-to-one with the terminal devices he is operating.

Further, the management server can generate a runtime or an executable program based on the zero-knowledge proof circuit and send the same to the terminal device, so as to transplant the circuit to the terminal device for use in the subsequent verification process. In addition, the management server can also obtain a device certificate cert generated for the terminal device based on the zero-knowledge proof circuit. The certificate can be generated by the management server or its associated construction server, which is not limited in the present disclosure. Also, the construction server can use the vector X and random data r as common input parameters to generate the proof parameter pk and verification parameter vk of the zero-knowledge proof circuit. Here, the proof parameter pk can be sent to the server. The verification parameter vk and the device certificate can be sent to the management server and forwarded by the management server to the authentication server. Here, the management server mentioned in the above registration process can be the server where the server of the online system mentioned in the present disclosure is located, so that the client in the terminal device used by the target user can register with the server through the above method.

Correspondingly, the authentication server can maintain locally a mapping relationship between the vectors X of registered terminal devices and their device certificates. Then, when the target evaluation data interacts with the server through the client running in the terminal device, the authentication server can authenticate the terminal device based on this mapping relationship to obtain an authentication result for the client.

When interacting with the server, the client can first send the vector X and the proof parameter to the server, so that the server can determine the terminal device based on the vector X, and generate an authentication proof proof with a random number and the proof parameter of the terminal device. The authentication server can then authenticate and obtain the corresponding authentication result.

After the registration is completed, the user can log in to the client using the user account assigned by self-registration, and then, after performing target evaluation behavior on the target object on the client, the target evaluation data can be submitted by the client with the identity of the user account to the blockchain node for storage. The submission method of the data is related to whether the terminal device on which the client is located is a node device. The method can be found in the previous embodiments, and will not be repeated here.

At Step 204, the target evaluation data is stored separately to the user blockchain network and the object blockchain network through the blockchain node.

After obtaining the target evaluation data, the node device can store the data to the user blockchain network and the object blockchain network through the locally deployed blockchain nodes. Considering that the on-chain storage space of blockchain is relatively valuable and the process of upload data to the chain (i.e. storing data to a blockchain ledger) and download data from the chain (obtaining data from a blockchain ledger) is more cumbersome than the regular data reading and writing process, it is necessary for node devices to first review the obtained target evaluation data to ensure that necessary data passing the review can be stored to the chain.

In one embodiment, even if the client of the target user sends real data to the node device, the uncontrollable data transmission process may cause the target evaluation data received by the node device to be tampered with (i.e., the node device may not receive the real data sent by the target user). This can be resolved through data signing. For example, the client of the target user can maintain its own private key and disclose the corresponding public key to enable node devices to obtain the public key. Thus, the client can use the private key to sign the target evaluation data generated by the user, and send the signature along with the encrypted ciphertext target evaluation data to the node device. Correspondingly, after receiving the to-be-verified signature data, the node device can use the previously obtained public key to verify the data and its signature. In the case of successful verification, it can be considered that the received signature data was indeed sent by the client of the target user and has not been tampered with. Therefore, it is necessary to store the real data. However, in the case of failed signature verification, it can be considered that the received to-be-verified signature data was not sent by the client of the target user and may have been tampered with. Therefore, the forged data does not need to be stored. In this case, the data can be directly discarded or corresponding notification messages can be returned to the client. It can be seen that through signature verification, falsified data that has been tampered with by third parties can be identified, thereby avoiding unnecessary data being stored in the blockchain.

In another embodiment, the target user may also generate falsified data, for example, if the user is a real natural person but the target evaluation data is generated by a falsified order (for example, the user is engaging in clicking farming behavior), or if the user is a fake account (such as an account generated by controlling multiple terminal devices to register in bulk through technical means, which is not used by a real natural person, it can also be considered a fake account). It usually produces batch of falsified data. To identify the falsified data mentioned above and avoid storing it in the blockchain network, node devices can determine a diversity degree of evaluations of the user based on historical evaluation records of the target user, and store it in any blockchain network when the diversity degree of evaluations satisfies a preset threshold of diversity degree. Here, the above historical evaluation records can be maintained by the node device per se (for example, the node device is a server), or can also be obtained from the maintenance party of the records. The diversity degree of a user can be used to characterize diversities of types pf his evaluation records. For example, if a user only purchases or evaluates a certain type of objects, or if his evaluation content only has scores without text or other content, the diversity degree of his evaluations is usually low. On the contrary, the more types of objects and content styles the user evaluates, the higher his diversity degree usually is. The evaluation contents published by the fake users is usually relatively monotonous, and the falsified data published by the real users may have significant differences from their own types of historical evaluation records. Based on this, an appropriate threshold of the diversity degree can be set according to actual situation to identify whether the received target evaluation data is real data. Here, one or more dimensional feature indicators can be extracted from the historical evaluation records, and the diversity degree can be calculated based on these indicators. The present disclosure does not limit the specific calculation method. For the identified real data, it can be determined that it is necessary to store it in the blockchain network. On the contrary, there is no need to store the data in the blockchain network, and the data can be directly discarded or corresponding notification messages can be returned to the client. It can be seen that falsified data generated by real or fake users can be identified based on diversity degree to avoid unnecessary data being stored in the blockchain.

In addition, the obtained target evaluation data can be reviewed in other dimensions through other means, which will not be further elaborated. Moreover, the above-mentioned verification methods such as signature verification and diversity degree verification can be used separately or in combination, and the present disclosure does not limit this. Then, if the target evaluation data passes the review, the target evaluation data can be stored.

In one embodiment, if one blockchain node is deployed in the node device, the target evaluation data can be stored in the user blockchain network and the object blockchain network separately through the blockchain node. As shown in FIG. 3, the node device can send the obtained (or passing the review) target evaluation data to node0, which can generate a first transaction containing the data and submit it to the user blockchain network for consensus by nodes such as node0, node12, and node13. Once the consensus is passed, the transaction is executed separately to complete the storage of the data. During the execution of the above transaction, additional processing of the data may be required, and the corresponding processing logic can be recorded in the smart contract deployed by the user's blockchain network. At this point, each node can call the contract separately to process the target evaluation data. In addition, node0 can also generate a second transaction containing target evaluation data and submit it to the user blockchain network to complete the storage of the data. The specific transaction consensus and execution process are similar to the above and will not be repeated.

In another embodiment, if a first blockchain node belonging to the user blockchain network and a second blockchain node belonging to the object blockchain network are separately deployed in the node device, the node device can store the target evaluation data to the user blockchain network through the first blockchain node, and store the target evaluation data to the object blockchain network through the second blockchain node. As shown in FIG. 4, the node device can send the obtained (or passing the review) target evaluation data to node11 and node22, respectively. Afterwards, node11 can store the data in chain1 by submitting and executing transactions. Similarly, node22 can store the data in chain2 by submitting and executing transactions. Furthermore, it should be noted that storing the data separately in the user blockchain network corresponding to the target user and the object blockchain network corresponding to the target object, even if the structure of either blockchain is relatively simple (such as a private or federated chain), it is technically difficult for a perpetrator to tamper with the target evaluation data in the same way in both blockchains. Therefore, compared to only storing the data in one blockchain network, this solution can further improve the security and consistency of the stored data.

Specifically, blockchain nodes can update target evaluation data to the blockchain ledger to achieve the storage of the data. For example, the node device can generate a first evaluation block and a second evaluation block based on the target evaluation data, and then update the first evaluation block to the first blockchain ledger maintained by the user blockchain network, and update the second evaluation block to the second blockchain ledger maintained by the target blockchain network. As shown in FIG. 4, node11 is used to maintain the blockchain ledger of chain 1. An evaluation block in the ledger can correspond to one evaluation behavior implemented by the target user, and the node can update the first evaluation block generated by the blockchain node to the blockchain ledger. node21 is used to maintain the blockchain ledger of chain 2, where an evaluation block in the ledger can correspond to one evaluation behavior implemented on the target object. The node can update the second evaluation block generated by the blockchain node to the blockchain ledger.

Here, nodes in a blockchain network can separately maintain the blockchain ledger of that network. The evaluation blocks in the blockchain ledger are sequentially connected in the order of generation time to form a chain structure, and the order of the positions of any two evaluation blocks in the blockchain ledger, that is, the order in which the evaluation behaviors corresponding to the two evaluation blocks occur—the earlier the evaluation behavior occurs, the higher the position of the evaluation block in the blockchain ledger is. Specifically, in the case where each block contains evaluation data generated by one evaluation behavior, the occurrence time (i.e. the time when the corresponding user implements or ends the behavior) of the evaluation behavior corresponding to the previous block of the blockchain is earlier than the occurrence time of the current behavior, while the occurrence time of the evaluation behavior corresponding to the subsequent block of the blockchain is later than the occurrence time of the current behavior. In the case where each block contains evaluation data generated by adjacent multiple evaluation behaviors, the multiple pieces of evaluation data contained within the block can be sorted and recorded according to the occurrence times of the corresponding evaluation behaviors, or the evaluation data can contain the time information of the corresponding evaluation behavior. At this point, the evaluation behaviors corresponding to the previous block of the blockchain occur earlier than the recorded evaluation behaviors in the current block, while the evaluation behaviors corresponding to the subsequent block of the blockchain occur later than the recorded evaluation behaviors in the block. Based on this, updating any evaluation block to the corresponding blockchain ledger is equivalent to mounting the evaluation block to the end of the blockchain ledger (i.e. the tail of the chain structure).

For any of the aforementioned user blockchain network and object blockchain network, the chain structure of the blockchain ledger maintained by them can be seen in FIG. 5. In blocks 0 to 3 as shown in FIG. 5, any block contains a block head and a block body, and adjacent blocks are connected through the block head. In order to achieve this connection, the block header of the subsequent block can record the relevant summary of the previous block, such as a summary of all the contents of the previous block (including block header and block body), a summary of the previous block header, or a summary of the previous block body. Taking the previous block as an example, the block header of block 1 can contain a summary of block 0, block 2 can contain a summary of block 1, and block 3 can contain a summary of block 2. It can be understood that data summaries have the characteristic of changing with data contents. Therefore, if the data in any block changes, the summary of that block will also change immediately. At this point, the changed summary will be inconsistent with the summary of that block recorded in the header of the subsequent block, and it can be found that the content of the previous block has been tampered with.

In the case where the first evaluation block is the first block of the first blockchain ledger, the node device can set the identity information of the target user as the ledger identification of the first blockchain ledger. As mentioned earlier, the first user blockchain network corresponds to the target user, and the first blockchain ledger maintained by the network naturally corresponds to the target user (different users corresponding to different user blockchain networks and different blockchain ledgers maintained). Therefore, the identity information of the user can be used to label the first blockchain ledger. For example, the identity information can be recorded in the block header of the first evaluation block; Alternatively, it can be recorded in an index file or a configuration file of the first evaluation block maintained by the node device. Here, the identity information of the target user can be the account name or ID assigned by the server during the registration process, or a nickname, a personal signature, and other information that can be used to uniquely identify the target user, in order to distinguish the user from other users.

Similarly, in the case where the second evaluation block is the first block of the second blockchain ledger, the node device can set the identification information of the target object as the ledger identification of the second blockchain ledger. As mentioned earlier, the second user blockchain network corresponds to the target object, and the second blockchain ledger maintained by the network naturally corresponds to the target object (different objects corresponding to different user blockchain networks and different blockchain ledgers maintained). Therefore, the identification information of the object can be used to label the second blockchain ledger. For example, the identification information can be recorded in the block header of the second evaluation block. Alternatively, it can be recorded in an index file or a configuration file of the second evaluation block maintained by the node device. Here, the identification information of the target object can be a resource ID, a stock keeping unit (SKU) of the product, identification code of commodity, and other information that can be used to uniquely identify the target object, in order to distinguish it from other objects.

In addition, the first block mentioned above should be placed at the initial position of the corresponding blockchain ledger, as the starting point of the chain structure. As shown in FIG. 5, block 0 can correspond to the first evaluation behavior implemented by the target user.

According to different considerations, the evaluation blocks generated by node devices can contain different evaluation data.

In one embodiment, to ensure the integrity of the saved data, the node device can generate a first evaluation block based on first historical evaluation data and the target evaluation data, and generate a second evaluation block based on second historical evaluation data and the target evaluation data. Here, the first historical evaluation data is generated by the target user performing first historical evaluation behavior on at least one object before the target evaluation behavior, and the second historical evaluation data is generated by at least one user performing second historical evaluation behavior on the target object before the target evaluation behavior. It can be seen that this solution records all evaluation data generated by all evaluation behaviors implemented before any given time in the block generated at the given time. If the chain structure shown in FIG. 5 is the first blockchain ledger, and blocks 0 to 3 correspond to the evaluation behaviors 0 to 3 implemented for different objects in the target evaluation data, then block 0 records evaluation data generated by evaluation behavior 0, block 1 records evaluation data generated by evaluation behavior 0 and evaluation behavior 1, block 2 records evaluation behavior 0, evaluation data generated by evaluation behavior 1 and evaluation behavior 2, and block 3 records evaluation behavior 0, evaluation data generated by evaluation behavior 1, evaluation behavior 2, and evaluation behavior 3, and so on, which will not be repeated.

In another embodiment, in order to save storage space of the chain and reduce the amount of data that needs to be processed for a single storage, the node device can generate a first evaluation block based on the data summary of the first historical evaluation data and the target evaluation data, and generate a second evaluation block based on the data summary of the second historical evaluation data and the target evaluation data, wherein, the first and second historical evaluation data mentioned above are as mentioned earlier and will not be repeated here. It can be seen that this solution records the evaluation data generated by the corresponding evaluation behavior in the generated blocks at any time. If the chain structure shown in FIG. 5 is the second blockchain ledger, and blocks 0 to 3 correspond to the evaluation behaviors 0 to 3 implemented for different objects in the target evaluation data, then block 0 records the evaluation data generated by evaluation behavior 0, block 1 records the evaluation data generated by evaluation behavior 1, block 2 records the evaluation data generated by evaluation behavior 2, and block 3 records the evaluation data generated by evaluation behavior 3, and so on, which will not be elaborated. At this point, the historical evaluation data at any time is stored in the form of a data summary in the current evaluation block, while its complete data is stored in the historical evaluation block generated at the corresponding time and located before the evaluation block, which can reduce the amount of data to ensure that the data volume of each evaluation block does not differ greatly, facilitating the maintenance of the blockchain ledger and rapid search of related evaluation data in the future. In addition, the summary of any data or block described in the present disclosed embodiment can be a hash of the data or block. Correspondingly, the data or block (which is essentially still a piece of data) can be used as input and calculated through a hash algorithm. The specific process will not be repeated.

In practice, the structure of any evaluation block in any blockchain ledger described in this solution can be the same as the block structure in related art. However, it can also be different. In addition to generating block headers based on data summaries mentioned earlier, the corresponding data can be recorded in the block headers and block bodies of any of the evaluation blocks mentioned above. For example, for the first blockchain ledger, the block header of the initial first evaluation block (block 0 shown in FIG. 5) can record the user identification of the target user, and can also record the object identification and time information of the target object targeted by the first evaluation behavior (such as the time when the behavior occurred or completed, which can be a timestamp, the same for below). The block headers of the subsequent first evaluation blocks (such as blocks 1-4 shown in FIG. 5) can record the object identification and time information of the target object targeted by the corresponding evaluation behavior. For the second blockchain ledger, the block header of the initial second evaluation block (block 0 shown in FIG. 5) can record the object identification of the target user, and can also record the user identification of the user who implemented the first evaluation behavior and time information. The block headers of the subsequent second evaluation blocks (such as blocks 1-4 shown in FIG. 5) can record the user identification of the user who implemented the corresponding evaluation behaviors and time information. The block body of the evaluation block corresponding to any of the above evaluation behaviors can record the evaluation content data generated by that behavior, such as comment content, rating, descriptive words, etc. It can be seen that the target evaluation data described in the present disclosure can include the user identification and/or object identification, time information, and evaluation content data mentioned above.

Considering that evaluation behavior usually corresponds to the user's purchase behavior, such as evaluating a product after purchase the product, in any of the above evaluation blocks, in addition to recording target evaluation data, target purchase data generated by the target user's target purchase behavior on the target object can also be recorded. For example, when storing the target evaluation data, the node device can obtain the target purchase data corresponding to the target evaluation behavior, and then associate and store the target evaluation data and target purchase data to any of the aforementioned blockchain networks. With this method, the target evaluation data and the target purchase data corresponding to the target evaluation behavior can be associated to each other and stored, which facilitates subsequent associating and obtaining the above data for data processing and helps to improve data processing efficiency.

In addition, the evaluation data and purchase data corresponding to any evaluation behavior may contain private information related to the target user, such as user name, purchase amount, purchase time (corresponding to the aforementioned time information), payment account, etc. Therefore, it is possible to avoid storing the above private information in the target evaluation data and/or target purchase data, while only verifying storing other non-private information, in order to achieve anonymous evaluation of the target user, protect their personal privacy. However, even if specific time information is not saved in the evaluation block, each evaluation block can still be generated in the order corresponding to the time information and mounted as mentioned above, completing the effective storage of other necessary data.

In order to further protect the personal privacy of the target evaluation data and ensure the privacy of the stored data, each data hash stored in the user blockchain network and object blockchain network can be encrypted. Taking target evaluation data as an example, node devices can encrypt the data and store the encrypted ciphertext evaluation data to any of the user blockchain networks mentioned above. With this method, even if the stored data is maliciously obtained by other devices, it cannot decrypt the data, thus effectively achieving the private storage of the data.

For example, node devices can use the Scrypt algorithm to encrypt the target evaluation data. Specifically, the target evaluation data can be filled in first and converted into n 512-bit message blocks (where n is an integer greater than 1). Then a random number is generated and a hash algorithm (such as SHA256, SHA-384, etc.) is operated on a first message block and the random number to obtain a first hash calculation result. Then, the first hash calculation result and the second message block are used as inputs to the hash algorithm to calculate a second hash calculation result. So on so forth, the hash calculation result obtained after processing the last message block (the nth message block) is used as the ciphertext evaluation data obtained by encrypting the target evaluation data. Through this algorithm, both the privacy and the integrity of target evaluation data can be ensured.

With the method described in the aforementioned embodiments, effective storage of target evaluation data can be achieved. In order to incentivize the target user to cooperate in completing the storage, the node device can allocate an available benefit corresponding to the target evaluation data and/or target evaluation behavior to the target user in response to determining that the target evaluation data has been successfully stored to the user blockchain network and/or target blockchain network. For example, in the case where the storage is completed by various nodes in any blockchain network executing blockchain transactions, the node device can monitor the storage completion event generated by executing the transactions. If the event is successfully monitored, it can be determined that the target evaluation data has been successfully stored in the network. At this point, the node device can trigger allocation of a corresponding benefit to the target user, which can be allocated by the node device itself or by the online system server. The benefit can be in any form such as credit points, vouchers, discount coupons, cash (electronic form), activity participation quotas, etc. The present disclosure does not limit this. Taking the allocation of credit points to node devices as an example, node devices can determine how many credit points to allocate to target users based on various factors such as the amount of stored data (such as comment words), comment timeliness, and purchase amount, which will not be further elaborated.

In addition, any evaluation data stored in the ledger described above can be obtained by a data requester. For example, when any user browses a page of the target object through a client, the client can request from the node device to obtain target evaluation data stored in the blockchain network about the object for display to the user. The user can be the target user who implements the target evaluation behavior (i.e., the user can view his own comments published by himself), or the user can also be any other user, such as any other user who can view the comments posted by the target user on the target object; Of course, this user can also be an administrator, auditor, etc. of the online system. However, the requester can also be a server, an auditor, or other data processing parties, and the present disclosure does not limit this. Here, for the initiator of the data acquisition request, the request is initiated for any evaluation behavior, which can include the time information of the evaluation behavior, the user identification of the user who implemented the evaluation behavior, and the object identification of the object corresponding to the evaluation behavior. Correspondingly, node devices can submit data acquisition transactions in both the user blockchain network and the object blockchain network in response to data acquisition requests, and obtain the corresponding to-be-verified data by executing the transaction, in order to achieve reliable storage of the data acquisition process and facilitate subsequent review.

In this case, the node device can obtain stored first to-be-verified data from the user blockchain network, and obtain stored second to-be-verified data from the object blockchain network based on the time information and the user identification. For the first to-be-verified data, considering that different user blockchain networks (and the first blockchain ledger) correspond to different users, in the case where the node device is in the server, there may be multiple first blockchain ledgers respectively corresponding to the multiple users locally maintained by the node device. At this point, the node device can search in the first blockchain ledgers for the first blockchain ledger corresponding to the user identification based on the user identification included in the data acquisition request, and search for the corresponding block in the ledger based on the time information, and then obtain the first to-be-verified data such as evaluation content from the block body of the block. In the case where the node device is in a terminal device running a client with any user, the node device may only locally maintain the first blockchain ledger corresponding to the user. At this point, the node device can directly search for the corresponding block in the ledger based on the time information, and then obtain the first to-be-verified data such as evaluation content from the block body of the block. For the second to-be-verified data, whether the node device is in the server or in a terminal device of any user, it can usually maintain second blockchain ledgers for multiple objects. At this point, the node device can search in the second blockchain ledgers for the second blockchain ledger corresponding to the object identification based on the object identification included in the data acquisition request, and search for the corresponding block in the ledger based on the time information, thereby obtaining evaluation content and other second to-be-verified data from the block body of the block.

Furthermore, the node device can compare the first and second to-be-verified data to determine if they are consistent. Specifically, the node device can compare two data bit by bit; Alternatively, in order to obtain the comparison result as soon as possible, the hash of the first and second to-be-verified data can also be calculated, and when the two hashes are equal, it can be determined that the specific content of the two data remains consistent, that is, the first and second to-be-verified data are identical. Thus, when it is determined that the two data are identical, the node device can return the data to the requesting party. When the two data are different, it indicates that either data has been tampered with, and in this case, it can avoid returning the data and return a corresponding notification message to the requesting party. In addition, it is also possible to determine whether the first to-be-verified data or the second to-be-verified data has been tampered with based on the hash recorded in subsequent blocks of the block in which the data is located, in order to correct it in a timely manner. It can be seen that the data stored in the user blockchain network is in the user dimension, while the data stored in the object blockchain network is in the object dimension. Therefore, cross verification on data from multiple dimensions mentioned above helps to fully ensure the authenticity of the stored data.

In one embodiment, after the target evaluation data is stored in the first and second blockchain networks, the target user or management may need to control the read permissions of the data. For example, after a target user posts a comment, there may be a need to delete the comment or set it as an anonymous comment (visible only to himself). In this case, the user can initiate a comment cancellation request for the target evaluation data through the client. In response to this request, the node device can trigger the blockchain node to execute a corresponding evaluation cancellation transaction, in order to freeze the permission of a preset type of blockchain node to read the target evaluation data by executing the transaction. Here, the above transaction can be generated by the node device and sent to blockchain nodes for submission; Alternatively, the node device can send evaluation cancellation requests to blockchain nodes to generate and submit corresponding evaluation cancellation transactions.

Taking the structure in FIG. 4 as an example, the node device can send the evaluation cancellation request to node11 to generate the first evaluation cancellation transaction and submit it to the chain for execution. After execution, other nodes than the node corresponding to the target user (such as node11) will not be able to read (read permissions are frozen, the same for below) the stored target evaluation data. Similarly, the node device can send the evaluation cancellation request to node21 to generate a second evaluation cancellation transaction and submit it to chain2 for execution. After execution, nodes other than the node corresponding to the target user (such as node21) will not be able to read the stored target evaluation data. Since the node corresponding to the server and other users cannot read the target evaluation data, the evaluation corresponding to the data will also not be displayed in other users' clients, thus achieving the effect of deleting the comment or only being visible to oneself.

According to the embodiments of the present disclosure, blockchain nodes belonging to the user blockchain network and the object blockchain network are deployed in the node device, wherein the user blockchain network is used to store evaluation data generated by the evaluation behavior of the target user for at least one object, and the object blockchain network is used to store evaluation data generated by the evaluation behavior of at least one user on the target object. Based on this, after obtaining the target evaluation data generated by the target evaluation behavior of the target user on the target object, the node device can store the data separately to the user blockchain network and the object blockchain network through the blockchain node.

Through the blockchain node, the target evaluation data generated by the target user implementation target evaluation behavior can be stored separately in the user blockchain network and the object blockchain network. On the one hand, reliable storage of this data can be achieved based on the technical capabilities of the two blockchain networks themselves. On the other hand, cross verification can also be performed between the target evaluation data stored separately in the two blockchain networks, thereby further ensuring the security and consistency of the stored data.

Corresponding to the embodiments of the data storage method, the present disclosure also provides embodiments of a data storage apparatus.

An embodiment of the present disclosure provides a data storage apparatus, which is applied to a node device deployed with a blockchain node. The blockchain node belongs to a user blockchain network and an object blockchain network, the user blockchain network is used to store evaluation data generated by evaluation behavior of a target user on at least one object, the object blockchain network is used to store evaluation data generated by at least one user performing evaluation behavior on the target object, and the apparatus includes one or more processors, which are configured to:
obtain target evaluation data on a target object, the target evaluation data being generated by the target user performing a target evaluation behavior on the target object;
store the target evaluation data separately to the user blockchain network and the object blockchain network through the blockchain node.

In one embodiment, the blockchain node includes a first blockchain node belonging to the user blockchain network and a second blockchain node belonging to the object blockchain network, and the processors are further configured to:
store the target evaluation data to the user blockchain network through the first blockchain node, and store the target evaluation data to the object blockchain network through the second blockchain node.

In one embodiment, the processors are further configured to:
generate a first evaluation block and a second evaluation block respectively based on the target evaluation data;
update the first evaluation block to a first blockchain ledger maintained by the user blockchain network, and update the second evaluation block to a second blockchain ledger maintained by the object blockchain network.

In one embodiment, the processors are further configured to:
generate a first evaluation block based on first historical evaluation data and the target evaluation data, and generate a second evaluation block based on second historical evaluation data and the target evaluation data; or,
generate a first evaluation block based on data summary of the first historical evaluation data and the target evaluation data, and generate a second evaluation block based on data summary of the second historical evaluation data and the target evaluation data;
wherein the first historical evaluation data was generated by the target user performing a first historical evaluation behavior on at least one object before the target evaluation behavior, and the second historical evaluation data was generated by at least one user performing the second historical evaluation behavior on the target object before the target evaluation behavior.

In one embodiment, the processors are further configured to:
when the first evaluation block is a first block of the first blockchain ledger, set identity information of the target user as a ledger identification of the first blockchain ledger; and/or,
when the second evaluation block is a first block of the second blockchain ledger, set identification information of the target object as a ledger identification of the second blockchain ledger.

In one embodiment, the processors are further configured to:
encrypt the target evaluation data and store the encrypted ciphertext evaluation data in any blockchain network.

In one embodiment, the processors are further configured to:
obtain target purchase data corresponding to the target evaluation behavior, the target purchase data being generated by the target user performing target purchase behavior on the target object;
associate the target evaluation data with the target purchase data and store the target evaluation data and the target purchase data in any blockchain network.

In one embodiment, a signature generated from a private key of the target user is added by a client of the target user to the target evaluation data, and the processors are further configured to:
verify the signature with a public key of the client;
in response to the signature is verified, store the target evaluation data in any blockchain network.

In one embodiment, the processors are further configured to:
determine a diversity degree of evaluations of the target user based on historical evaluation records of the target user;
in response to the diversity degree of evaluations meeting a preset diversity degree threshold, store the target evaluation data to any blockchain network.

In one embodiment, the target user is pre-registered to a server, and a corresponding registration process is implemented based on a zero-knowledge proof algorithm.

In one embodiment, a proof circuit of the zero-knowledge proof algorithm is generated according to identity information of the target user and/or device information of the terminal device used by the target user.

In one embodiment, the processors are further configured to:
in response to determining that the target evaluation data has been successfully stored in the user blockchain network and/or the object blockchain network, trigger allocation of an available benefit corresponding to the target evaluation data and/or the target evaluation behavior to the target user.

In one embodiment, the processors are further configured to:
in response to an evaluation cancellation request initiated for the target evaluation data, trigger the blockchain node to execute a corresponding evaluation cancellation transaction, the evaluation cancellation transaction being used to freeze a permission of a preset type of blockchain nodes to read the stored target evaluation data.

In one embodiment, the processors are further configured to:
receive a data acquisition request initiated by a requesting party for any evaluation behavior, the acquisition request including time information of the evaluation behavior, a user identification of the user who implemented the evaluation behavior, and an object identification of a corresponding object of the evaluation behavior;
obtain a stored first to-be-verified data from the user blockchain network based on the time information and the object identification, and obtain a stored second to-be-verified data from the object blockchain network based on the time information and the user identification;
if the first to-be-verified data and the second to-be-verified data are identical, return the data to the requesting party.

An embodiment of the present disclosure further provides an electronic device, including: a processor; a memory used to store processor executable instructions; wherein the processor is configured to implement the data storage method described in any of the above embodiments.

An embodiment of the present disclosure further provides a non-transitory computer-readable storage medium on which a computer program is stored, wherein, when executed by the processor, the computer program implements steps of the data storage method described in any of the above embodiments.

Regarding the apparatus in the above embodiment, the specific ways in which each module performs operations have been described in detail in the relevant method embodiments, which will not be elaborated here.

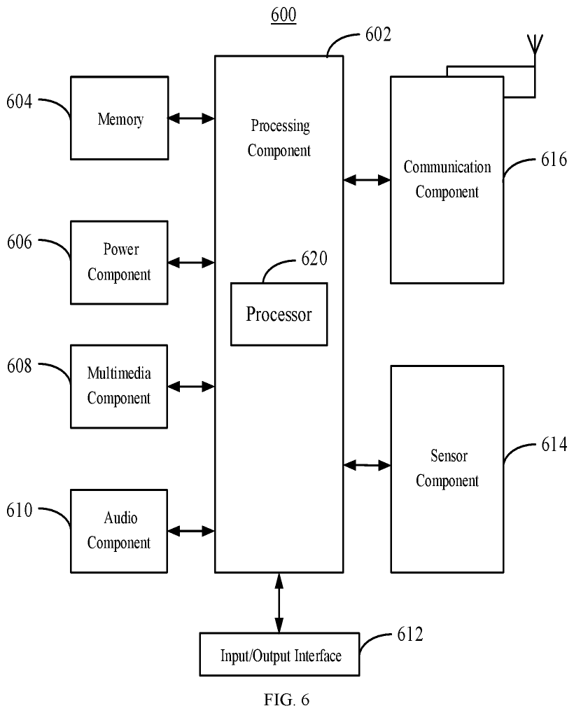

FIG. 6 is a block diagram of a device 600 for data storage or determining a driving mode according to an embodiment of the present disclosure. For example, the device 600 may be a mobile phone, a computer, a digital broadcast terminal, a messaging device, a gaming console, a tablet, a medical device, exercise equipment, a personal digital assistant, and the like.

The device 600 may include one or more of the following components: a Processing Component 602, A Memory 604, A Power Component 606, A Multimedia Component 608, An Audio Component 610, An Input/Output (I/O) Interface 612, A Sensor Component 614, And A Communication Component 616.

The processing component 602 typically controls overall operations of the device 600, such as the operations associated with display, telephone calls, data communications, camera operations, and recording operations. The processing component 602 may include one or more processors 620 to execute instructions, to perform all or part of the steps of the above method. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, or 3G, 4G LTE, 6G NR or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, to perform the above method.

In exemplary embodiments, there is also provided a non-transitory computer-readable storage medium including instructions, such as included in the memory 604, executable by the processor 620 in the device 600 to perform the above method. For example, the non-transitory computer-readable storage medium may be a ROM, a RAM, a CD-ROM, a magnetic tape, a floppy disc, an optical data storage device, and the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the disclosure only be limited by the appended claims.

It should be noted that in the context herein, relational terms such as first and second are only used to distinguish one entity or operation from another entity or operation, and do not necessarily require or imply any actual relationship or order between these entities or operations. The terms “including”, “comprising”, or any other variation thereof are intended to encompass non-exclusive inclusion, such that a process, a method, an item, or a device that includes a series of elements not only includes those elements, but also other elements that are not explicitly listed, or also include elements inherent in such a process, a method, an item, or a device. Without further limitations, the elements limited by the statement “including one . . . ” do not exclude the existence of other identical elements in the process, method, item, or device that includes the said elements.

The above provides a detailed introduction to the method and device provided in the disclosed embodiments. Specific examples are applied herein to explain the principles and implementation methods of the present disclosure. The explanations of the above embodiments are only used to help understand the methods and core ideas of the present disclosure. Meanwhile, for general technical personnel in this field, there may be changes in specific implementation methods and application scope based on the ideas of the present disclosure. In summary, the content of this specification should not be understood as a limitation of this disclosure.

1. A data storage method comprising:
obtaining target evaluation data on a target object, the target evaluation data being generated by the target user performing target evaluation behavior on the target object;
storing the target evaluation data separately to a user blockchain network and an object blockchain network through a blockchain node.

2. The method according to claim 1, wherein the blockchain node comprises a first blockchain node in the user blockchain network and a second blockchain node in the object blockchain network, wherein storing the target evaluation data comprises:
storing the target evaluation data to the user blockchain network through the first blockchain node, and storing the target evaluation data to the object blockchain network through the second blockchain node.

3. The method according to claim 1, wherein storing the target evaluation data comprises:
generating a first evaluation block and a second evaluation block respectively based on the target evaluation data;
updating the first evaluation block to a first blockchain ledger maintained by the user blockchain network, and updating the second evaluation block to a second blockchain ledger maintained by the object blockchain network.

4. The method according to claim 3, wherein generating the first evaluation block and the second evaluation block comprises:
generating the first evaluation block based on first historical evaluation data and the target evaluation data, and generating the second evaluation block based on second historical evaluation data and the target evaluation data; or,
generating the first evaluation block based on data summary of the first historical evaluation data and the target evaluation data, and generating the second evaluation block based on data summary of the second historical evaluation data and the target evaluation data;
wherein the first historical evaluation data was generated by the target user performing a first historical evaluation behavior on at least one object before the target evaluation behavior, and the second historical evaluation data was generated by at least one user performing a second historical evaluation behavior on the target object before the target evaluation behavior.

5. The method according to claim 3, further comprising:
setting identity information of the target user as a ledger identification of the first blockchain ledger, wherein the first evaluation block is a first block of the first blockchain ledger; or,
setting identification information of the target object as a ledger identification of the second blockchain ledger, wherein the second evaluation block is a first block of the second blockchain ledger.

6. The method according to claim 1, wherein storing the target evaluation data comprises:
encrypting the target evaluation data and storing the encrypted ciphertext evaluation data.

7. The method according to claim 1, wherein storing the target evaluation data comprises:
obtaining target purchase data corresponding to the target evaluation behavior, the target purchase data being generated by the target user performing target purchase behavior on the target object;
storing the target purchase data with the target evaluation data.

8. The method according to claim 1, wherein a signature generated from a private key of the target user is added by a client of the target user to the target evaluation data comprise a signature generated by a client of the target user from a private key of the target user, and storing the target evaluation data comprises:
verifying the signature with a public key of the client;
in response to the signature is verified, storing the target evaluation data.

9. The method according to claim 1, wherein storing the target evaluation data comprises:
determining a diversity degree of evaluations of the target user based on historical evaluation records of the target user;
in response to the diversity degree of evaluations meeting a preset diversity degree threshold, storing the target evaluation data to.

10. The method according to claim 1, wherein the target user is pre-registered to a server, and a corresponding registration process is implemented based on a zero-knowledge proof algorithm.

11. The method according to claim 10, wherein a proof circuit of the zero-knowledge proof algorithm is generated according to identity information of the target user and/or device information of a terminal device used by the target user.

12. The method according to claim 1, further comprising:
in response to determining that the target evaluation data has been successfully stored in the user blockchain network or the object blockchain network, triggering allocation of an available benefit corresponding to the target evaluation data and/or the target evaluation behavior to the target user.

13. The method according to claim 1, further comprising:
in response to an evaluation cancellation request initiated for the target evaluation data, triggering the blockchain node to execute a corresponding evaluation cancellation transaction that freezes a permission of a preset type of blockchain nodes to read the stored target evaluation data.

14. The method according to claim 1, further comprising:
receiving a data acquisition request initiated by a requesting party for an evaluation behavior, the acquisition request comprising time information of the evaluation behavior, a user identification of a user who implemented the evaluation behavior, and an object identification of a corresponding object of the evaluation behavior;
obtaining a stored first to-be-verified data from the user blockchain network based on the time information and the object identification, and obtaining a stored second to-be-verified data from the object blockchain network based on the time information and the user identification;
upon determination that the first to-be-verified data and the second to-be-verified data are identical, returning the data to the requesting party.

15. A data storage apparatus comprising one or more processors configured to:
obtain target evaluation data on a target object, the target evaluation data being generated by the target user performing target evaluation behavior on the target object;
store the target evaluation data separately to a user blockchain network and an object blockchain network through a blockchain node.

16. The apparatus according to claim 15, wherein the blockchain node comprises a first blockchain node in the user blockchain network and a second blockchain node in the object blockchain network, and the processors are further configured to:
store the target evaluation data to the user blockchain network through the first blockchain node, and store the target evaluation data to the object blockchain network through the second blockchain node.

17. The apparatus according to claim 15, wherein the processors are further configured to:
generate a first evaluation block and a second evaluation block respectively based on the target evaluation data;
update the first evaluation block to a first blockchain ledger maintained by the user blockchain network, and update the second evaluation block to a second blockchain ledger maintained by the object blockchain network.

18. The apparatus according to claim 17, wherein the processors are further configured to:
generate the first evaluation block based on first historical evaluation data and the target evaluation data, and generate the second evaluation block based on second historical evaluation data and the target evaluation data; or,
generate the first evaluation block based on data summary of the first historical evaluation data and the target evaluation data, and generate the second evaluation block based on data summary of the second historical evaluation data and the target evaluation data;
wherein the first historical evaluation data was generated by the target user performing a first historical evaluation behavior on at least one object before the target evaluation behavior, and the second historical evaluation data was generated by at least one user performing a second historical evaluation behavior on the target object before the target evaluation behavior.

19.-28. (canceled)

29. An electronic device comprising:
a processor; a memory used to store processor executable instructions;
wherein the processor is configured to implement the method according to claim 1.

30. A non-transitory computer-readable storage medium on which a computer program is stored, wherein, when the program is executed by a processor, the computer program implements steps of the method according to claim 1.
